(19) United States
(12) Patent Application Publication
(10) Pub. No.: US 2024/0386667 A1
(43) Pub. Date: Nov. 21, 2024

(54) HANDHELD PERSONAL DEVICE FOR PROVIDING CUSTOMIZED CONTENT BY A VIRTUAL DOCENT

(71) Applicant: Maris Jacob Ensing, Orange, CA (US)

(72) Inventor: Maris Jacob Ensing, Orange, CA (US)

(21) Appl. No.: 18/760,129

(22) Filed: Jul. 1, 2024

Related U.S. Application Data
(63) Continuation-in-part of application No. 18/221,954, filed on Jul. 14, 2023, now abandoned.
(60) Provisional application No. 63/467,278, filed on May 17, 2023.

(51) Int. Cl. G06T 17/00

(52) U.S. Cl. CPC G06T 17/00

(57) ABSTRACT

A handheld personalized device for providing customized content includes a recognition device including a scanner configured to identify a user and the presence of the user at a venue. The venue includes at least one point of interest. The device includes a processor and at least one memory in communication with the processor. The device includes a virtual docent system in communication with the processor and the memory. The memory stores computer instructions configured to instruct the processor to instruct the virtual docent system to generate custom content for the point(s) of interest in the venue. The virtual docent system is configured to generate an avatar to present the custom content to the user. The device includes a transmitter in communication with the virtual docent system. The transmitter is configured to generate a visual representation of the virtual docent viewable by the user to display the custom content.

### CROSS-REFERENCE TO RELATED APPLICATION

The present Non-Provisional Patent Application is a Continuation-In-Part of U.S. patent application Ser. No. 18/221,954, filed on Jul. 14, 2023, which claims priority to U.S. Provisional Patent Application No. 63/467,278, filed on May 17, 2023, the entire contents of each of which are incorporated by reference herein.

### FIELD

The present disclosure relates to a device for providing customized content and, more particularly, to a handheld personal device for providing customized content by a virtual docent.

### BACKGROUND

There are many types of media delivery systems used by companies, such as, for example, billboards, service kiosks, drive-through windows, and gas station pumps, that display media to consumers in a variety of locations, such as, for example, museums, galleries, theme parks, audience centers, zoos, and roads. Often, to enhance the viewer experience, these media delivery systems will provide media content, for example to inform, educate or entertain a target audience, and/or to advertise goods or services. The media content is often played back on a display, speakers, headphones, and/or other playback devices, such as, for example, a portable or handheld device.

### SUMMARY

Provided in accordance with aspects of the present disclosure is a handheld personal device for providing customized content. The handheld personal device includes a recognition device including a scanner configured to identify at least one user and the presence of the at least one user at a venue. The venue includes at least one point of interest. The handheld personal device includes a processor and at least one memory in communication with the processor. The handheld personal device includes a virtual docent system in communication with the processor and the at least one memory. The memory stores computer instructions configured to instruct the processor to instruct the virtual docent system to generate custom content for the point(s) of interest in the venue. The virtual docent system is configured to generate an avatar to present the custom content to the user. A transmitter is in communication with the virtual docent system. The transmitter is configured to generate a visual representation of the virtual docent viewable by the user. The custom content is presented to the user by the virtual docent.

In an aspect of the present disclosure, the handheld personal device includes a network interface configured to communicate with a machine learning model. The network interface is configured to receive a body of knowledge related to the point(s) of interest to generate the custom content by the virtual docent system.

In an aspect of the present disclosure, the point of interest of the venue includes a number of points of interest. The network interface is configured to communicate wirelessly with each of the points of interest.

In an aspect of the present disclosure, the virtual docent system is configured to customize a physical appearance of the avatar.

In an aspect of the present disclosure, the virtual docent system is configured to update the body of knowledge for the point(s) of interest of the venue. The virtual docent system is configured to generate updated custom content for the user based on the updated body of knowledge, the identified user preferences for the user, and the detected location of the user in the venue. The virtual docent system is configured to present the updated custom content to the user.

In an aspect of the present disclosure, the virtual docent system is configured to update the body of knowledge by communicating with a machine learning model including an artificial neural network.

In an aspect of the present disclosure, the virtual docent system is configured to generate custom content for the user based on at least one of preferred language, preferred learning style, visual presentation for the hearing impaired, auditory presentation for the visually impaired, tactile presentation for the visually impaired, preferred presentation style based on education level, or preferred presentation style based on personal interests.

In an aspect of the present disclosure, the venue at which the presence of the user is identified is a museum, an exhibit, a theater, a public space, a theme park, a retail establishment, a restaurant, a cruise ship, a hotel, a resort, a sports arena, a sports stadium, a city, or a smart city.

In an aspect of the present disclosure, the recognition device is configured to identify the user by at least one of facial recognition, scanning a bar code, scanning a QR code, or receiving a near-field communication signal.

In an aspect of the present disclosure, the point of interest of the venue includes a number of points of interest. The virtual docent system is configured to generate an itinerary and a path of travel for the user between the points of interest based on the identified user preferences.

Provided in accordance with aspects of the present disclosure is a system for providing customized content including a recognition device configured to identify a user and the presence of the user at a venue. The venue includes at least one point of interest. A virtual docent system is in communication with the recognition device. The virtual docent system is in communication with a neural network. The virtual docent system is configured to compile a body of knowledge for the at least one point of interest of the venue. The virtual docent system is configured to identify user preferences for the user. The virtual docent system is configured to detect a location of the user in the venue with respect to the point of interest of the venue. The virtual docent system is configured to generate custom content for the user based on the compiled body of knowledge, the identified user preferences for the user, and the detected location of the user in the venue. The generated custom content is updated concurrently with the presence of the user at the venue. The virtual docent system is configured to present the custom content to the user. The presented custom content includes at least one of audio, visual or tactile content.

In an aspect of the present disclosure, the neural network includes an artificial intelligence (AI) drive search module and/or a natural language processing module. The generated custom content is updated concurrently with the presence of the at least one user at the venue by the AI driven search module and/or the natural language processing module.

In an aspect of the present disclosure, the virtual docent system is configured to generate an avatar, and present at least some of the generated custom content by the avatar.

In an aspect of the present disclosure, the virtual docent system is configured to customize a physical appearance of the avatar.

In an aspect of the present disclosure, the virtual docent system includes a wireless transmitter configured to connect with a handheld device carried by the user. The virtual docent system is configured to generate a virtual docent in the handheld device carried by the user. The virtual docent is configured to present at least some of the generated custom content.

In an aspect of the present disclosure, the virtual docent system is configured to update the body of knowledge for each point of interest of the venue. Updated custom content is generated for the user based on the updated body of knowledge, the identified user preferences for the user, and the detected location of the user in the venue. The updated custom content is presented to the user.

In an aspect of the present disclosure, the virtual docent system is configured to generate custom content for the user based on at least one user preference selected from preferred language, preferred learning style, visual presentation for the hearing impaired, auditory presentation for the visually impaired, tactile presentation for the visually impaired, preferred presentation style based on education level, or preferred presentation style based on personal interests.

In an aspect of the present disclosure, the venue at which the presence of the user is identified is a museum, an exhibit, a theater, a public space, a theme park, a retail establishment, a restaurant, a cruise ship, a hotel, a resort, a sports arena, or a sports stadium.

In an aspect of the present disclosure, the recognition device is configured to identify the user by facial recognition, scanning a bar code, scanning a QR code, and/or receiving a near-field communication signal.

In an aspect of the present disclosure, the venue includes multiple points of interest. The virtual docent system is configured to generate an itinerary and a path of travel for the user between the points of interest based on the identified user preferences.

Provided in accordance with aspects of the present disclosure is a computer-implemented method of providing customized content including compiling a body of knowledge for at least one point of interest of a venue. The method includes identifying at least one user and the presence of the user(s) at the venue. The method includes identifying user preferences for the user. The method includes detecting a location of the user in the venue with respect to the at least one point of interest. The method includes generating custom content for the user based on the identified user preferences and the detected location of the user in the venue. The method includes updating the generated custom content for the user. The generated custom content for the user is updated concurrently with the presence of the user at the venue. The method includes presenting the custom content to the user. The presented custom content includes at least one of audio, visual or tactile content.

In an aspect of the present disclosure, the method includes generating an avatar and presenting at least some of the generated custom content by the avatar.

In an aspect of the present disclosure, the method includes customizing a physical appearance of the avatar.

In an aspect of the present disclosure, the method includes updating the body of knowledge for the at least one point of interest of the venue. The method includes generating updated custom content for the user based on the updated body of knowledge, the identified user preferences for the user, and the detected location of the user in the venue. The method includes presenting the updated custom content to the user.

In an aspect of the present disclosure, the venue includes multiple points of interest, and the method includes generating an itinerary and a path of travel for the user between the points of interest based on the identified user preferences.

### BRIEF DESCRIPTION OF THE DRAWINGS

Various aspects and features of the present disclosure are described hereinbelow with reference to the drawings wherein:

FIG. 1 is a schematic diagram of a system for providing customized content by a virtual docent according to aspects of the present disclosure;

FIG. 2 is a schematic diagram of an artificial intelligence system employable by the system for providing customized content by a virtual docent of FIG. 1;

FIG. 3 is a flow chart of a computer-implemented method of providing customized content by a virtual docent according to aspects of the present disclosure;

FIG. 4 is a flow chart of another computer-implemented method of providing customized content by a virtual docent according to aspects of the present disclosure;

FIG. 5 is a flow chart of another computer-implemented method of providing customized content by a virtual docent according to aspects of the present disclosure;

FIG. 6 is a block diagram of an exemplary computer for implementing the method of providing customized content by a virtual docent according to aspects of the present disclosure;

FIG. 7 is a schematic diagram of a system for providing customized content by a virtual docent generated by a virtual docent system operating on a smartphone or personalized handheld device according to aspects of the present disclosure; and

FIG. 8 is a schematic diagram of a system for providing customized content by a virtual docent generated by a virtual docent system operating with a cloud-based machine learning model according to aspects of the present disclosure.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings). Like reference numerals may refer to like elements throughout the specification and drawings.

A virtual docent according to aspects of the present disclosure employs artificial intelligence (AI) to create uniquely tailored museum experiences and other experiences in different fields and verticals for the widest possible audience. By understanding a visitor's interests, historical or artistic preferences, and levels of knowledge, the system and method described herein crafts a real-time, adaptive narrative that guides each individual through a bespoke journey of discovery. For example, a user standing in front of the Mona Lisa can hear an analysis of the painting that caters to the user's personal fascination with Renaissance art. In another example, a user exploring the mysteries of the Rosetta Stone can experience a narrative that aligns with the user's interest in ancient civilizations.

According to aspects of the present disclosure, the museum experience is not a one-way transmission of monolithic information, but a dynamic, interactive experience that evolves iteratively with a user's changing curiosity and interests, as they develop over time, which can enhance a user's engagement with the custom content described herein.

The device and system described herein can adapt to different languages and cater to various learning styles to create a more inclusive experience that transcends language barriers and caters to diverse visitor needs. Whether the user is a student on a field trip, an art enthusiast, a history buff, or a tourist exploring new cities, the virtual docent system provides an enriching and personalized journey.

The device and system described herein may integrate facial recognition and tracking devices to determine a user's experience of customized content. The device and system may detect and interpret a user's reactions in real-time, using this data to adapt and tailor experiences to an increased degree of personalization.

By optionally generating unique custom content for each user concurrently with each engagement with a particular point of interest (e.g., in a venue such as a museum, exhibit, retail establishment, sports arena, theme park, or an interconnected city such as a smart city), a user's content experience dynamically changes during any engagement with the point of interest.

Facial recognition or other recognition procedures, as described herein, allow user stored preferences (or acquired user preferences) to be employed to generate a personalized avatar, which be utilized as a user's custom guide or docent. Facial and body language tracking (e.g., tracking smiles, facial expressions and/or body language indicative of intrigue, or facial expression and/or body language indicative indifference) can be employed to read a user's reactions to both a point of interest and the custom content presented for the point of interest to gauge a user's degree of satisfaction with a particular set of custom content. Real-time facial and body language tracking can be employed to generate feedback to adapt a user's experience of a venue continuously. For example, if a particular artwork in a museum sparks a look of awe, the virtual docent system might steer the user towards similar pieces or provide deeper insights into the artist who made the artwork. In another example, in a shopping mall, if a certain style of clothing elicits a positive reaction, an avatar might suggest similar items or stores known for that style.

Suggestions or content delivered might relate to personal interest or biases from user registration and/or feedback acquired from sensors or user interfaces like surveys on an interactive touchscreen or a Point Of Sale transaction. Custom content can be cultivated in a customized manner from a robust body of knowledge related to a particular point of interest. The point of interest can be, for example, a location, an attraction, an exhibit in a venue, art, sculpture, an invention, a display, and the body of knowledge may include all known information currently available about a particular point of interest.

The body of knowledge referred to herein may be used to derive the custom content described herein. The body of knowledge may refer to anything that an AI system can find or access, a subset of available information, or a given amount of data that is identified for developing custom content (e.g., a chapter of a book, or a narrative written by an expert).

The body of knowledge may include information acquired from live sources (e.g., live news broadcasts, current print articles, or current scientific publications or announcements) which can be accumulated and prepared for citation before being added to the body of knowledge.

The body of knowledge may include images (still or video images), or data derived from such images, or audio transmissions or recordings. Images, video, and/or audio may be integrated into custom content presented to a user from the body of knowledge.

While custom content that is specific and personalized to a particular user based on identified user preferences is described herein, up to date general audience content may similarly be generated by the virtual docent system. For example, one or more users may be provided with a general presentation at one or more of the points of interest, without considering user preferences. However, the general presentation can be updated by the machine learning model to be currently. The general presentation can also be iteratively updated in real-time, such that an audience observing a point of interest multiple times in a same visit would receive two different content presentations as a result of the real-time updates to the presentation. For example, a presently occurring current event could change the content of a general audience presentation. Alternatively, the machine learning model may modify the general audience presentation to keep the content fresh, or to expand on the previous general audience presentation with additional background information. That is, even a general audience presentation can be iteratively unique, such that a user never experiences a same content experience twice.

While any of the presentations described herein can be updated in real-time, the user may also be provided with the ability to access any previously observed content. For example, a user can access a content presentation observed on a particular date or at a particular time. The user may access the particular presentation by using an alphanumeric code, or with a bar code, QR code, or a NFC signal that can be accessed and/or saved by the user.

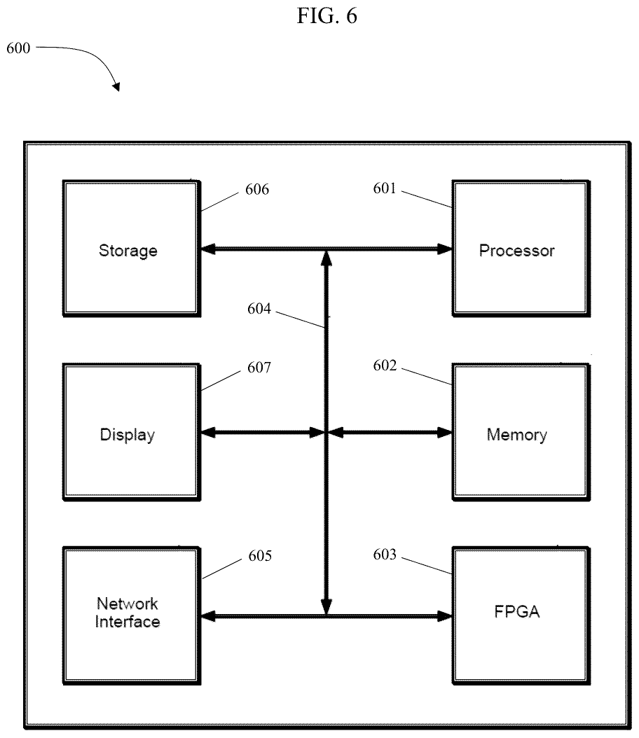

The virtual docent system including the machine learning model may operate on a local device, such as a localized server. The local device may include a processor and a memory. The local device may be a general purpose computer. A more detailed description of an exemplary general purpose computer is described in more detail below with reference to FIG. 6.

The virtual docent system including the machine learning model may operate on a handheld device carried by a user, such as a smartphone. The smartphone may include a processor and a memory.

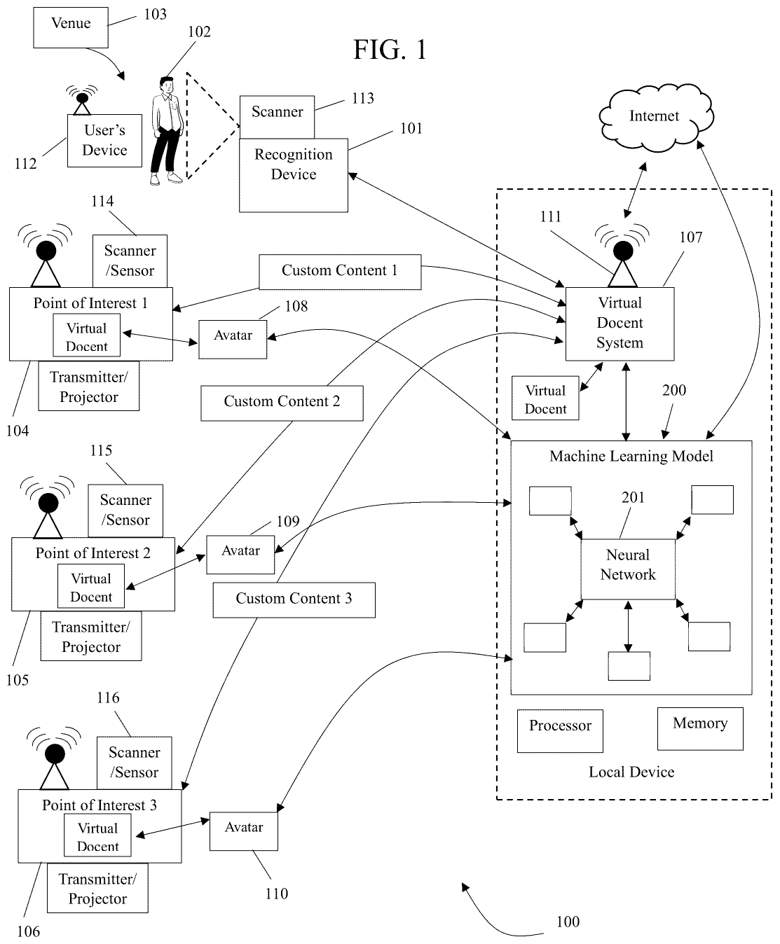

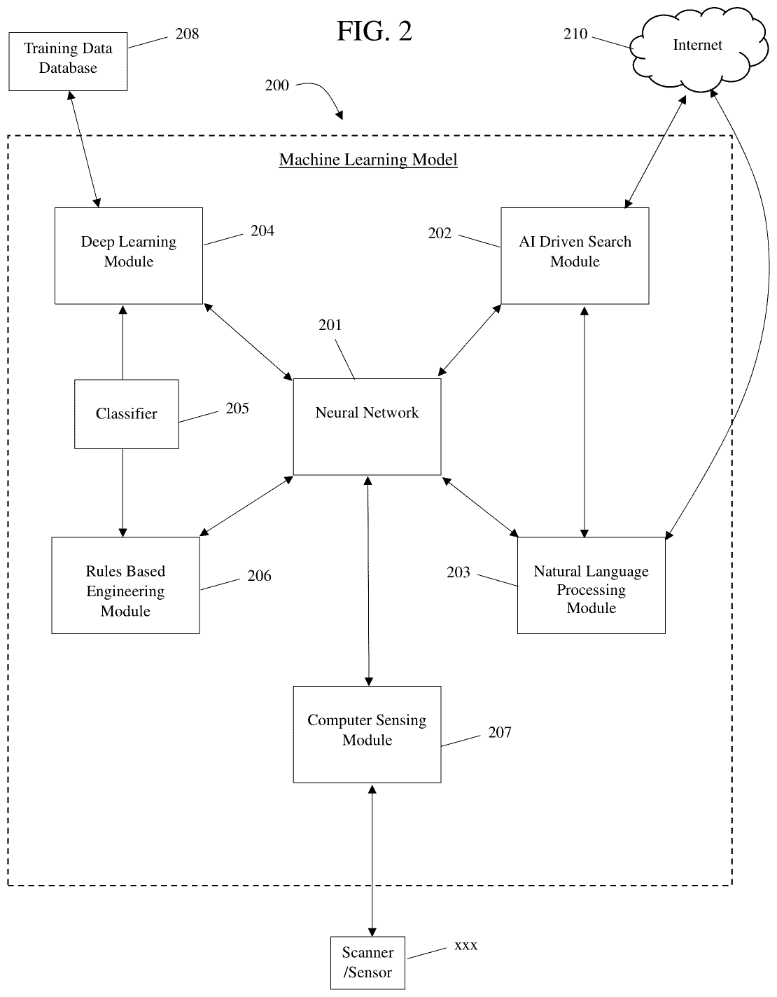

Referring particularly to FIGS. 1 and 2, a system 100 for providing customized content includes a recognition device 101 configured to identify a user 102 and the presence of the user 102 at a venue 103. The recognition device 101 may employ a scanner 113 to identify the user 102. The scanner 113 may include a facial recognition device, which may employ a camera, such as a still image camera or a video camera configured to capture one or more images of a user 102 for facial recognition. The scanner 113 may also include a bar code, QR code, or near field communication scanner configured to identify the user 102. For example, the scanner 113 may detect a signal or code presented by a user 102 to identify the user 102. The user 102 may be identified as the user enters or approaches a venue 103.

The venue 103 includes at least one point of interest (see, e.g., points of interest 104, 105, or 106). The point of interest may include, for example, a museum feature, an exhibit, an area of interest in a particular geographic area (e.g., a cultural artifact or structure), a work of art, or any other item of potential interest to a user 102.

A virtual docent system 107 is in communication with the recognition device 101. The virtual docent system 104 is in communication with a machine learning model including a neural network (see, e.g., machine learning model 200 including neural network 201 described in more detail with reference to FIG. 2). An exemplary architecture of the machine learning model employable by the virtual docent system is illustrated in FIG. 2. As an example, the machine learning model 200 may include the neural network 201 including or configured to communicate with a deep learning module 204, a classifier 205, a rules based engineering module 206, a computer sensing module 207, a natural language processing module 203, and/or an artificial intelligence (AI) drive search module 202. The Deep learning module 204 may access training data, such as training data stored in a training data database 208. The training data database 208 can be continuously updated with new/expanded training data. Training an AI module, such as a deep learning model, is described in more detail below. The classifier 205 may be employed by at least one of the deep learning module 204 or the rules based engineering module 206. The computer sensing module 207 may be employed in identifying a user 102 and/or with monitoring facial expressions and/or body language of a user 102 to monitor a user's reaction to a particular custom content that is presented to the user 102. The computer sensing module 207 may employ or interface with any of the scanner/sensors described herein (see, e.g., scanners/sensors 113, 114, 115, or 116 in FIG. 1). The AI drive search module 202 and/or the natural language processing module 203 may communicate with the internet 210 to receive data employable in generating the body of knowledge. Updated information may be captured from the internet 210 on a constant and instantaneous or near-instantaneous basis, such that the body of knowledge can always be maximally current and employed for use in generating custom content (e.g., based on user preferences).

The neural network 201 may refer to the architectural core of the machine learning model 200. The neural network 201 may take a set of inputs, pass the inputs through a series of hidden layers, in which each layer can transform the inputs, and then produce an output. The process of transforming the input is determined by the weights and biases of the neurons in the hidden layers of the neural network 201, which are learned from data during training of the neural network (see, e.g., training data database 208). The neural network 201 may include relatively simple (single layer) or relatively complex structures (multiple layers). The deep learning module 204 may employ a particular type of neural network (e.g., a Convolutional Neural Network) to process image data, while the classifier 205 may use another type of neural network (e.g., a Feed-Forward Neural Network) to make predictions based on the processed data.

The deep learning module 204 may be employed by the neural network 201. The deep learning module 204 may deliver high-dimensional representations of user data to the neural network 201. The neural network 201 may then use the information from the deep learning module 204 to learn complex patterns and inform the neural network's decision-making processes. Similarly, the classifier 205 may be employed by the neural network 201. The classifier 205 may use the neural network's output to categorize or classify inputs into different classes. Additionally, the neural network 201 may help guide the AI-driven search module 202 by helping to understand and rank content according to the content's relevance to the user. The AI-driven search module 202 may use the learned representations from the neural network 201 to better tailor search results. The neural network 201 may work with the natural language processing module 203 by generating language representations that the natural language processing module 203 may use for understanding and generating text. The neural network may employ the sensory data from the computer sensing module 207 to help inform the neural network's understanding of the user's context. For example, location data from the computer sensing module 207 may be employed to adjust recommended custom content according to the user's location within the venue.

The computer sensing module 207 may process sensory data received at the machine learning module 200. For example, the computer sensing module 207 may process location data from a user's smartphone or from beacons located within the venue. Additionally, the computer sensing module 207 may collect information about the user and the user's environment. To collect user data, the computer sensing module 207 can interface with various hardware devices (e.g., scanners/sensors), such as for example, cameras for facial recognition, microphones for detecting a user's spoken inquiries, location sensors for tracking the user's location within the venue, or an app (e.g., a smartphone application or an application running on a local computer) for collecting direct user feedback (e.g., direct user feedback may include ratings or comments). This user feedback data may include the user's real-time reaction to custom content delivered by the system. A user's reaction may be analyzed via audio, video, or user review data.

Sensory inputs from the computer sensing module 207 may be employed to deliver real-time custom content. The computer sensing module 207 may transmit sensory data to the deep learning module 204. The sensory data can be processed by the deep learning module 204 to provide insight into the user's behavior or preferences. For example, the user's facial expressions may be used to assess the user's interest or engagement level.

This real-time user feedback can be used to further personalize the custom-content delivered to the user (e.g., a user displaying disinterest in a particular topic may be given less content about that topic). This real-time user feedback can be used to affect the type of content chosen by the classifier 205. The real-time user feedback may be used by the rules-based engineering module 206 to modify the type of content given to the user. The rules-based engineering module 206 may execute one or more rule based algorithms relating to user behavior, for example, if the user is determined to be bored or distracted. In that circumstance, the machine learning model 200 would use the senor data to infer the user's state of boredom or distraction and implement rules to increase user engagement, such as be executing one or more rule based algorithm by the rules based engineering module 206.

Data from the computer sensing module 207 can be used by the AI-driven search module 202 to refine content retrieval and ranking. For example, if a user displays a strong engagement level with a certain type of content, the AI-driven search module 202 may prioritize similar content in its search results. Audio feedback from the user in the form of commands or questions can be employed by the natural language processing module 203 to understand these inquiries and modify content delivery accordingly.

The deep learning module 204 can be employed for generating embeddings and high-dimensional representations of the user data. The deep learning module 204 can receive data inputs such as user age, gender, education, interests, interaction history at the venue, and transform these inputs into a representation of the user's underlying preferences. The outputs from the deep learning module 204 can be employed by the other modules within the machine learning model 200 to make predictions about what content to deliver to a particular user. Over the course of predictions and feedback, the deep learning module 204 can become more accurate in determining user preferences.

The output from the deep learning module 204 can serve as the primary output for the classifier 205. The classifier 205 can receive the outputs from the deep learning module 204 and use those outputs to make decisions about what content to deliver to the user. Feedback from the classifier 205 can then be used to adjust and refine the outputs from the deep learning module 204. The deep learning module output can act on the rules-based engineering module 206 to inform and update the rule-based engineering module's rule implementation. For example, if the deep learning module 204 determines the user has a high degree of interest in a topic, then a rule might be triggered to provide more complex or detailed content related to the particular topic. Outputs from the deep learning module 204 can be used by the AI-driven search module 202 to inform the AI-driven search module's prioritization of content. For example, if the deep learning module 204 determines user interest in a particular topic, then the AI-driven search module 202 can prioritize identifying and delivering updated information about that specific topic to the user. Speech or text user inputs received from a user (e.g., via the computer sensing module 207) can be transformed into a high-dimensional representation that the natural language processing module 203 can interpret.

The classifier 205 can receive inputs and assign a class label to those inputs. The classifier 205 can take the embedded generated outputs from the deep learning module 204 and make a prediction about the type of content a user is likely to be interested in. For example, at a museum, an art lover would be directed to art exhibits. Particularly, if the user was a Picasso fan then the user would be directed to Picasso exhibits. However, the content the Picasso fan would receive would vary depending on the user's specific characteristics. If the user was a well-versed Picasso fan, then this user would receive more complex and expert-level content than a user with little to no Picasso knowledge. The classifier 205 can be employed in selecting the general content, and the particular content from a more general category of content, to be delivered to the user after determining the content applicable to the user's unique characteristics.

The classifier 205 can work in tandem with the rules-based engineering module 206. After the classifier 205 makes predictions, but before the predicted content is relayed to the user, the predictions may be filtered or adjusted by the rules-based engineering module 206 to ensure the classifier's predictions comply with certain constraints or business rules. For example, certain content may be age restricted, in which case, the content may not be presented to a user under a certain age. Additionally, the classifier 205 may interact with the AI-driven search module 202 to focus the AI-driven search module 202 on content similar to what the classifier 205 determines is the most relevant content to the user. The classifier 205 may use feedback from the natural language processing module 203 to further refine content selection. For example, the natural language processing module 203 may interpret the user's input as expressing an interest in particular content, then the classifier 205 can prioritize delivery of that particular content.

The rules-based engineering module 206, by utilizing predefined logic and constraints (rules), can be employed to influence the machine learning model's output of real-time custom content. In the context of delivering custom content, the rules utilized by the rules-based engineering module 206 may relate to what kind of content to recommend or not recommend to a user based on a number of predetermined or generated constraints (e.g., based on age restrictions or classified levels of complexity). For example, the rules may be against recommending certain types of content to underage users, or rules about ensuring the system recommends a diverse set of content. The rules may also apply to edge cases that may not be well-covered by the data used to train the deep learning module 204. The rules-based engineering module 206 may allow for explicitly programmed decisions or behaviors to control the recommended custom-content. The rules utilized by the rules-based engineering module 206 may be set in advance, added at a later time, or can be updated periodically to improve content output for a user. The rules may apply to ensure the custom content recommendations comply with ethical or legal guidelines established by the venue, for example.

The rules-based engineering module 206 may use the output from the deep learning module 204 to determine which rules apply to the user. For example, if the deep learning module 204 determines the user is a child, then the rules-based engineering module 206 would enforce rules applicable to children. Additionally, the rules-based engineering module 206 may adjust recommendations from the classifier 205. For example, if the classifier 205 recommends an exhibit that is closed, then the rules-based engineering module 206 could override the classifier's decision. The rules-based engineering module 206 may take location data from the computer sensing module 207 and invoke rules applicable to that particular location within the venue. The rules-based engineering module 206 may interact with the AI-driven search module 202 to help guide the AI-driven search module 202 in finding content, or information to be incorporated into the content. For example, the machine learning model 200 may employ a rule that the AI-driven search module 202 prioritizes recent or popular content. The machine learning model 200 may employ rules about certain types of language (e.g., descriptive language, technical language, particular levels of vocabulary or terminology) or about interpreting certain user inputs. Thus, the rules-based engineering module 206 may invoke rules that directly operate on the natural language processing module 203.

The AI-driven search module 202 may be used to search either on the internet or other available content (e.g., content stored in a database) to find content most relevant to user's specific interests and needs. The AI-driven search module 202 may use a collaborative filtering technique to find content that similar users have interacted with or may use content-based filtering to find content that is similar to items the particular user has interacted with in the past. The AI-driven search module 202 may also use reinforcement learning to continually improve the module's recommendations. For example, the AI-driven search module 202 may, over time, and through interaction with other modules of the machine learning model 200, learn which type of recommendations lead to positive user reactions and prioritize similar content in the future. The AI-driven search module 202 may also use real-time user feedback to adjust recommendations instantaneously or substantially instantaneously.

The AI-driven search module 202 may use the outputs from the deep learning module 204 to create a deeper understanding of the user's interests. The deep learning module 204 output may help the AI-driven search module 202 rank and retrieve the most relevant content to deliver to the user. Additionally, the AI-driven search module 202 may use classification outputs from the classifier 205 to guide the search. For example, a user classified as an “expert Picasso enthusiast” (e.g., by the classifier 205) may help the AI-driven search module 202 prioritize delivery of high-level content related to Picasso exhibits. The rules invoked by the rules-based engineering module 206 may modulate the prioritization of content retrieved by the AI-driven search module 202. The neural network 201 may provide learned representations that are then used by the AI-driven search module 202 to rank and retrieve the most relevant custom content. The AI-driven search module 202 may employ the natural language processing module 203 to better understand text-based user inputs.

The natural language processing module 203 may be employed by the machine learning model 200 to understand, interpret, generate, and interact with spoken or written human language. This may include understanding user queries or understanding text-based content. The natural language processing module 203 may be used to understand user feedback or enable text-based user interactions. For example, a user may be able to search for content via a natural language search. Additionally, the natural language processing module 203 may be used to generate human-like text responses that can be used to communicate with the user. This may also include generating the custom content delivered by the system. Moreover, the natural language processing module 203 may enable real-time dialogue between the user and the machine learning model 200, allowing the user to ask questions, provide feedback, or change their preferences in a natural, conversational way.

The natural learning processing module 203 may use the deep learning module 204 to process and understand human language inputs. The output from the deep learning module 204 may be used to enhance understanding and generation of natural language. The natural language processing module 203 may use the output from the classifier 205 to tailor the language used in response to a user (e.g., the system may use different vocabulary to convey custom content to a child versus an adult). The rules-based engineering module 206 can guide the natural language processing module's 203 use of certain phrases or preferring certain response types. The natural language processing module 203 may use the learned representations from the neural network 201 to better understand the semantics of the user's input and generate appropriate responses. The natural language processing module 203 may help guide the AI-driven search module 202 by interpreting user inquiries and thereby improving the AI-driven search module's 202 search effectiveness. The natural language processing module 203 may gather speech inputs from the computer sensing module 207 and transcribe and interpret those inputs.

The virtual docent system 107 is configured to compile a body of knowledge for the point(s) of interest (e.g., 104, 105, 106) of the venue 103. The virtual docent system 107 is configured to identify user preferences for the user 102. The user preferences may be previously determined, such as by a user 102 storing preferences in a database. The user preferences may be captured from a device, such as a smartphone carried by the user 102, or may be captured from a database, such as a cloud based database. The virtual docent system 107 may also determine use preferences for the user 102 based on available data from past user behavior. As an example, public data may be available indicating a level of education, language fluency, or physical disabilities for the user 102, and the virtual docent system 107 may determine user preferences based on this available data.

The virtual docent system 107 is configured to detect a location of the user 102 in the venue with respect to the point of interest of the venue 103. For example, a path of travel about various points of interest may be determined. For example, if a user 102 is approaching a particular point of interest, custom content related to that particular point of interest may be generated and continuously updated for presentation to the user 102.

The virtual docent system 107 is configured to generate custom content for the user 102 based on the compiled body of knowledge, the identified user preferences for the user 102, and the detected location of the user 102 in the venue 103. The generated custom content is updated concurrently with the presence of the user 102 at the venue 103. The virtual docent system 107 is configured to present the custom content to the user 102. The presented custom content includes at least one of audio, visual or tactile content. As an example, audiovisual data may be presented to the user 102, purely audio data may be presented to the user 102, or purely video data may be presented to the user 102. The custom content presented to the user 102 may include a combination of audio, visual, tactile, olfactory, or gustatory content. As an example, the tactile content may be brail.

The virtual docent system 107 may employ personalization based on what visitors have indicated they are interested in in order to generate their specific version of a display, story, presentation or other way to transfer information. This may include the automatic generation of text, audio, subtitles, video, written information, timing of lighting or effects or the like in real time (e.g., as the presentation is being generated) or out of real time (the story might be generated months ahead, or in a few seconds before the presentation is being done).

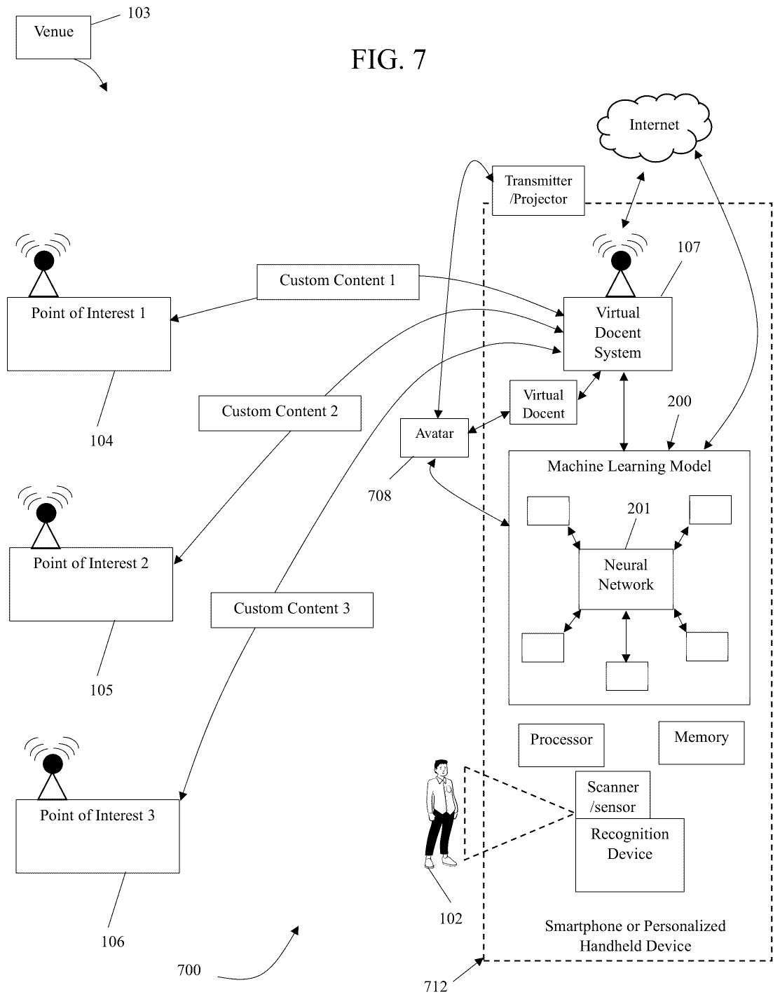

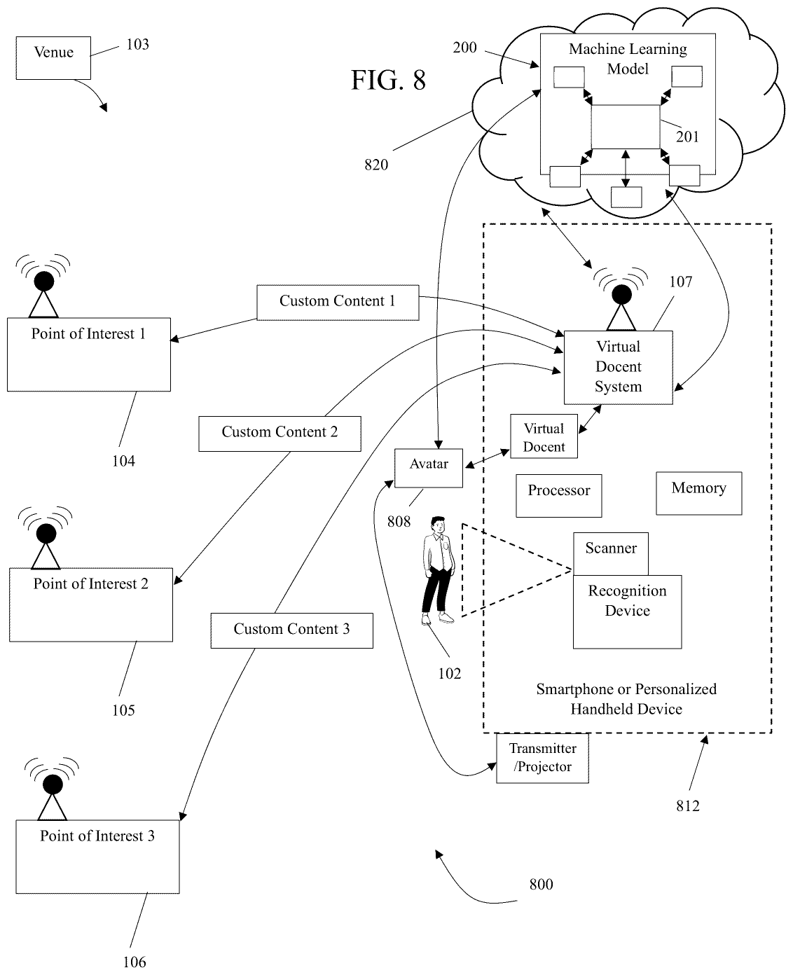

In an aspect of the present disclosure, the virtual docent system 107 is configured to generate an avatar (see, e.g., avatars 108, 109, or 110 in FIG. 1, 708 in FIG. 7 or 808 in FIG. 8), and present at least some of the generated custom content by the avatar. The avatar may be a free standing projection or may be displayed on a device carried by the user, such as a smartphone, or a special purpose device having audiovisual capabilities. That is, the generated avatar can act as a virtual docent generated by the virtual docent system 107 to present custom content to a user 102.

In an aspect of the present disclosure, the virtual docent system 107 is configured to customize a physical appearance of the avatar. For example, the avatar may appear as a known historical figure, a known public figure, or anyone else known to the user or that can be described by or selected by the user from a number of physical appearance options.

The avatar can be interactive and can communicate with the user 102. The avatar can employ the machine learning model 200 of the virtual docent system 107, such as to generate responses to user inquiries based on the most currently available information.

The avatar can act out any publicly known form of sign language (e.g., American sign language), such as based on a user preference to receive sign language. While an individual who utilizes sign language because of a physical disability may request sign language, any user 102 could also record a preference for receiving sign language content. For example, a user 102 might be studying sign language, and may want to see an avatar (e.g., on a device screen or as a projection of the avatar) perform sign language to assist with studying and learning sign language.

In an aspect of the present disclosure, the virtual docent system 107 includes a wireless transmitter 111 configured to connect with a handheld device 112 carried by the user 102. The virtual docent system 107 is configured to generate a virtual docent displayed in or by the handheld device 112 carried by the user 102. The virtual docent is configured to present at least some of the generated custom content. The virtual docent may display audio, visual, or audiovisual content to the user 102 based on the custom content generated by the virtual docent system 107.

In an aspect of the present disclosure, the virtual docent system 107 is configured to update the body of knowledge for each point of interest of the venue 103. Updated custom content is generated for the user 102 based on the updated body of knowledge, the identified user preferences for the user 102, and the detected location of the user 102 in the venue 103. The updated custom content is presented to the user 102.

As an example, the virtual docent system 107 is configured to generate custom content for the user 102 based on at least one user preference selected from preferred language, preferred learning style, visual presentation for the hearing impaired (e.g., subtitles), auditory presentation for the visually impaired, tactile presentation for the visually impaired, preferred presentation style based on education level, or preferred presentation style based on personal interests.

As an example, the venue 103 at which the presence of the user 102 is identified is a museum, an exhibit, a theater, a public space, a theme park, a retail establishment, a restaurant, a cruise ship, a hotel, a resort, a sports arena, or a sports stadium.

In an aspect of the present disclosure, the recognition device 101 is configured to identify the user 102 by facial recognition, scanning a bar code, scanning a QR code, and/or receiving a near-field communication signal. The recognition device 101 may include a scanner 113 configured to identify a user 102 by facial recognition, for example, or by a signal or data presented by a device (e.g., device 112) carried by the user 102, such as a smartphone. The recognition device 101 may also have a keypad or other data entry feature allowing a user 102 to manually identify who they are. The recognition device 101 can also be employed by the user to enter new or updated user preferences for use by the virtual docent system 107.

In an aspect of the present disclosure, the venue 103 includes multiple points of interest (see, e.g., points of interest 104, 105, or 106). The virtual docent system 107 is configured to generate an itinerary and a path of travel for the user 102 between the points of interest based on the identified user preferences.

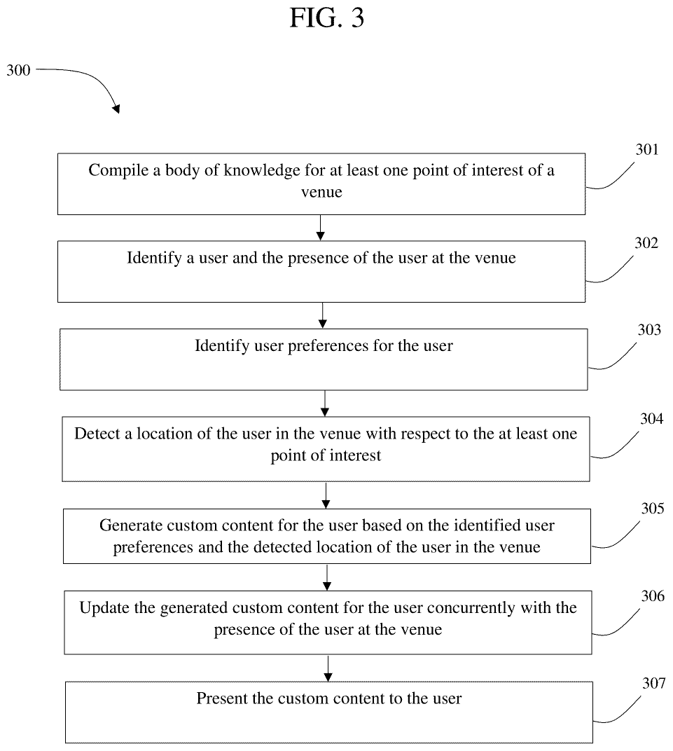

Referring particularly to FIG. 3, a computer-implemented method 300 of providing customized content includes compiling a body of knowledge for at least one point of interest of a venue 301. The method includes identifying at least one user and the presence of the user(s) at the venue 302. The method includes identifying user preferences for the user 303. The method includes detecting a location of the user in the venue with respect to the at least one point of interest 304. The method includes generating custom content for the user based on the identified user preferences and the detected location of the user in the venue 305. The method includes updating the generated custom content for the user 306. The generated custom content for the user is updated concurrently with the presence of the user at the venue. The method includes presenting the custom content to the user 307. The presented custom content includes at least one of audio, visual or tactile content.

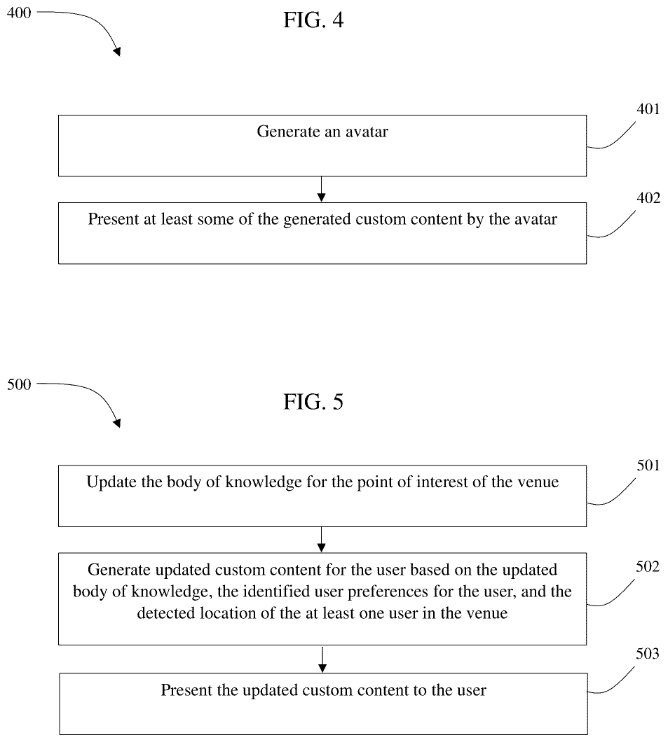

Referring particularly to FIG. 4, the method 400 includes generating an avatar 401 and presenting at least some of the generated custom content by the avatar 402.

In an aspect of the present disclosure, the method 400 includes customizing a physical appearance of the avatar.

Referring particularly to FIG. 5, the method 500 includes updating the body of knowledge for the at least one point of interest of the venue 501. The method includes generating updated custom content for the user based on the updated body of knowledge, the identified user preferences for the user, and the detected location of the user in the venue 502. The method includes presenting the updated custom content to the user 503.

In an aspect of the present disclosure, the venue 103 includes multiple points of interest, and the method includes generating an itinerary and a path of travel for the user 102 between the points of interest based on the identified user preferences.

Referring particularly to FIG. 6, a general-purpose computer 600 is described. The devices described herein (e.g., the local device or recognition device 101 of FIG. 1, or the smartphone or personalized handheld device 707 or 807 of FIG. 7 or 8, or a computer employed at or by any of the points of interest in FIG. 1, 7, or 8) may have the same or substantially the same structure as the computer 600 or may incorporate at least some of the components of the computer 600. The general-purpose computer 600 can be employed to perform the various methods and algorithms described herein. The computer 600 may include a processor 601 connected to a computer-readable storage medium or a memory 602 which may be a volatile type memory, e.g., RAM, or a non-volatile type memory, e.g., flash media, disk media, etc. The processor 601 may be another type of processor such as, without limitation, a digital signal processor, a microprocessor, an ASIC, a graphics processing unit (GPU), field-programmable gate array (FPGA) 603, or a central processing unit (CPU).

In some aspects of the disclosure, the memory 602 can be random access memory, read-only memory, magnetic disk memory, solid state memory, optical disc memory, and/or another type of memory. The memory 602 can communicate with the processor 601 through communication buses 604 of a circuit board and/or through communication cables such as serial ATA cables or other types of cables. The memory 602 includes computer-readable instructions that are executable by the processor 601 to operate the computer 600 to execute the algorithms described herein. The computer 600 may include a network interface 605 to communicate (e.g., through a wired or wireless connection) with other computers or a server. A storage device 606 may be used for storing data. The computer may include one or more FPGAs 603. The FPGA 603 may be used for executing various machine learning algorithms. A display 607 may be employed to display data processed by the computer 600.

Generally, the memory 602 may store computer instructions executable by the processor 601 to carry out the various functions described herein.

The computer 600 may employ various artificial intelligence models, such as one or more machine learning models or algorithms as part of the media generation module 119 and/or the media transmission device 108.

The classifier 205 may include a convolutional neural network (CNN, or ConvNet), a Bayesian network, a neural tree network, or a support-vector machine (SVM).

While a CNN may be employed, as described herein, other classifiers or machine learning models may similarly be employed. The machine learning model may be trained on tagged data. The trained CNN, trained machine learning model, or other form of decision or classification processes can be used to implement one or more of the methods, functions, processes, algorithms, or operations described herein. A neural network or deep learning model can be characterized in the form of a data structure storing data representing a set of layers containing nodes, and connections between nodes in different layers are formed or created that operate on an input to provide a decision or value as an output.

Machine learning can be employed to enable the analysis of data and assist in making decisions. To benefit from using machine learning, a machine learning algorithm is applied to a set of training data and labels to generate a “model” which represents what the application of the algorithm has “learned” from the training data. Each element (e.g., one or more parameters, variables, characteristics, or “features”) of the set of training data is associated with a label or annotation that defines how the element should be classified by the trained model. A machine learning model predicts a defined outcome based on a set of features of an observation. The machine learning model is built by being trained on a dataset which includes features and known outcomes. There are various types of machine learning algorithms, including linear models, support vector machines (SVM), Bayesian networks, neural tree networks, random forest, and/or XGBoost. A machine learning model may include a set of layers of connected neurons that operate to decide (e.g., a classification) regarding a sample of input data. When trained (e.g., the weights connecting neurons have converged and become stable or within an acceptable amount of variation), the model will operate on new input data to generate the correct label, classification, weight, or score as an output. Other suitable machine learning models may be similarly employed.

Referring particularly to FIG. 7, in system 700 the virtual docent system 107 may operate on a handheld device or a smartphone 712. The handheld device or smartphone 712 may detect a location of the user 102, generate custom content based on user preferences as described herein, and may present the generated custom data to the user 102. For example, the handheld device or smartphone 712 may present audio, video, or audiovisual content to the user 102 at the direction of the virtual docent system 107, and thus the handheld device or smartphone 712 may operate as a virtual docent. The handheld device or smartphone 712 may be a customized handheld device specifically designed to operate the virtual docent system 107, as described herein.

Referring particularly to FIG. 8, in system 800 the virtual docent system 107 may operate in the cloud-such or through interaction with a cloud-based server 820 that is accessible by any of the local device (see, e.g., FIG. 1), or the handheld device or smartphone 812. That is, the system and method described with reference to FIGS. 1-5 can also have a similar cloud-based machine learning model 200 including a neural network and/or a cloud-based virtual docent system that interacts with a local device.

Referring generally to FIGS. 1-8, the custom content may include, for example, recommended products in a retail environment, recommended exhibits or attractions, an itinerary, an ongoing narrative of various exhibits or displays, personalized fitness routines, exercise routines, or new points of interest in a particular venue.

As an example, the virtual docent system 107 can detect the environment a user 102 is traveling in and automatically generate custom content relevant to the environment. For example, the virtual docent system 107 may recognize you are at a national park and provide history narratives, trail suggestions, activity suggestions, or a mixed itinerary suggestion.

In an aspect of the present disclosure, the virtual docent system 107 may assist in the care of elderly or infirmed users, such as users with limited mobility. For example, the virtual docent system 107 may serve as a companion for the elderly, providing them with a personalized, engaging, and evolving interaction that can enhance their quality of life. By recognizing and responding to an individual's interests and preferences, the virtual docent system 107 can engage in meaningful conversations, suggest activities and/or provide reminders for medication or appointments. This personalized interaction can help alleviate feelings of loneliness and promote a more positive outlook. For example, if an individual shows interest in gardening, the virtual docent system can recommend relevant TV programs, provide gardening tips and/or suggest virtual tours of famous gardens around the world. The virtual docent system 107 can also adjust its communication style and pace to suit the individual, creating a more comfortable and effective communication environment.

In an aspect of the present disclosure, the virtual docent system 107 may assist in personalized learning. The virtual docent system 107 adapts to individual knowledge levels, learning styles, and interests, offering tailored educational content, explanations, and guidance. The system's interactive nature makes learning engaging, dynamic, and exciting.

In an aspect of the present disclosure, the virtual docent system 107 may guide individuals through complex environments such as museums, shopping malls, or smart cities. By providing real-time directions, recommendations, and personalized itineraries, the virtual docent system 107 ensures seamless navigation, making exploration more enjoyable and efficient.

In an aspect of the present disclosure, the virtual docent system 107 may connect like-minded individuals based on shared interests, fostering social interactions and communities. It may suggest group activities, facilitate communication, and provide platforms for collaboration, enabling individuals to form meaningful connections and combat isolation.

In an aspect of the present disclosure, the virtual docent system 107 may be integrated into smart city infrastructure, enhancing urban livability and efficiency. By analyzing data, monitoring services, and adapting to residents' needs, the virtual docent system may contribute to improved transportation systems, optimized city services, and personalized experiences within the urban environment.

In an aspect of the present disclosure, the virtual docent system 107 may assist in the hospitality industry, retail, or entertainment. The virtual docent system 107 may enhance customer experiences by personalizing interactions, recommending tailored products or services, and adapting to individual preferences. This fosters customer loyalty, engagement, and satisfaction.

In an aspect of the present disclosure, the virtual docent system 107 may be employed to generate and present customized/personalized advertising slogans. For example, if someone has a point-of-sale interaction, various products can be suggested through advertising.

As an example, if a user is procuring ingredients for certain dishes, then if they appear to be adventurous types or they are identified as engaging in impulsive purchases, then the virtual docent system 107 may recommend something similar but new or different to that particular user.

Sensors at points of interest can be cameras (video or still, digital cameras, cameras embodied in smartphones, tablet computer, or desktop computer).

The scanner/sensor described herein can include a camera and/or a microphone (e.g., a camera or microphone embodied in a smartphone or other handheld device, or a camera and microphone installed at a point of interest. This allows the virtual docent system to receive feedback from the user, such as by analyzing a user's reaction to content they are observing (e.g., via the computer sensing module of the machine learning model.

Connections between the various modules, hardware, and other components described herein may be achieved through either wired or wireless connections, such as wireless connections through WiFi, BlueTooth, or other short range wireless communication protocols (e.g., radio frequencies).

Audio content, as described herein, may be played through a speaker, headphones (e.g., wired or wireless headphones), or through a user's hearing aid(s).

Visual content, as described herein, may be presented on a screen, in smart glasses, or as a projection, such as a 3-D projection. As an example, the avatar described herein may be a 3-D projection.

Referring particularly to FIG. 8, a handheld personal device for providing customized content includes a recognition device including a scanner configured to identify at least one user and the presence of the at least one user at a venue. The venue includes at least one point of interest. The handheld personal device includes a processor and at least one memory in communication with the processor. The handheld personal device includes a virtual docent system in communication with the processor and the at least one memory. The memory stores computer instructions configured to instruct the processor to instruct the virtual docent system to generate custom content for the point(s) of interest in the venue. The virtual docent system is configured to generate an avatar to present the custom content to the user. A transmitter is in communication with the virtual docent system. The transmitter is configured to generate a visual representation of the virtual docent viewable by the user. The custom content is presented to the user by the virtual docent.

The handheld personal device may be a smartphone or tablet computer. Alternatively the handheld person device may be a specialized device configured to specifically operate in a particular venue, such as a museum.

The handheld personal device includes a network interface configured to communicate with a machine learning model. The network interface is configured to receive a body of knowledge related to the point(s) of interest to generate the custom content by the virtual docent system. The network interface may include a number of wired connections. Alternatively, the network interface may include a wireless receiver/transmitter configured to communicated with other computers, network, cloud-based systems, and the like via a wired connection. The network interface may be configured to provide wireless communication with Wi-Fi, cellular network, or Bluetooth communication platforms.

The venue may include a number of points of interest. The network interface is configured to communicate wirelessly with each of the points of interest. The network interface may similarly be configured to communicate via one or more wired connections.

In an aspect of the present disclosure, the virtual docent system is configured to customize a physical appearance of the avatar. For example, the physical appearance of the avatar may be modified based on user preferences.

The virtual docent system is configured to update the body of knowledge for the point(s) of interest of the venue. The virtual docent system is configured to generate updated custom content for the user based on the updated body of knowledge, the identified user preferences for the user, and the detected location of the user in the venue. The virtual docent system is configured to present the updated custom content to the user. The updated body of knowledge may be generated in real time, such that a user's experience within a venue is different day to day, or even hour to hour.

In an aspect of the present disclosure, the virtual docent system is configured to update the body of knowledge by communicating with a machine learning model including an artificial neural network. A more detailed description of an exemplary machine learning model is provided with reference to FIG. 2, in particular.

The virtual docent system may be configured to generate custom content for the user based on at least one of preferred language, preferred learning style, visual presentation for the hearing impaired, auditory presentation for the visually impaired, tactile presentation for the visually impaired, preferred presentation style based on education level, or preferred presentation style based on personal interests.

In an aspect of the present disclosure, the venue at which the presence of the user is identified is a museum, an exhibit, a theater, a public space, a theme park, a retail establishment, a restaurant, a cruise ship, a hotel, a resort, a sports arena, a sports stadium, a city, or a smart city.

The recognition device may be configured to identify the user by at least one of facial recognition, scanning a bar code, scanning a QR code, or receiving a near-field communication signal.

In an aspect of the present disclosure, the point of interest of the venue includes a number of points of interest. The virtual docent system is configured to generate an itinerary and a path of travel for the user between the points of interest based on the identified user preferences.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. A handheld personal device for providing customized content, comprising:
a recognition device including a scanner configured to identify at least one user and the presence of the at least one user at a venue, wherein the venue includes at least one point of interest;
a processor;
at least one memory in communication with the processor;
a virtual docent system in communication with the processor and the at least one memory, wherein the at least one memory stores computer instructions configured to instruct the processor to instruct the virtual docent system to generate custom content for the at least one point of interest in the venue, and wherein the virtual docent system is configured to generate an avatar to present the custom content to the user; and
a transmitter in communication with the virtual docent system, wherein the transmitter is configured to generate a visual representation of the virtual docent viewable by the user, wherein the custom content is presented to the user by the virtual docent.

2. The handheld personal device of claim 1, further including a network interface configured to communicate with a machine learning model, wherein the network interface is configured to receive a body of knowledge related to the at least one point of interest to generate the custom content by the virtual docent system.

3. The handheld personal device of claim 2, wherein the at least one point of interest of the venue includes a plurality of points of interest, and wherein the network interface is configured to communicate wirelessly with each point of interest of the plurality of points of interest.

4. The handheld personal device of claim 3, wherein the virtual docent system is configured to customize a physical appearance of the avatar.

5. The handheld personal device of claim 2, wherein the virtual docent system is further configured to:
update the body of knowledge for the at least one point of interest of the venue;
generate updated custom content for the at least one user based on the updated body of knowledge, identified user preferences for the at least one user, and a detected location of the at least one user in the venue; and
present the updated custom content to the at least one user.

6. The handheld personal device of claim 5, wherein the virtual docent system is configured to update the body of knowledge by communicating with a machine learning model including an artificial neural network.

7. The handheld personal device of claim 1, wherein the virtual docent system is configured to generate custom content for the at least one user based on at least one identified user preference of the identified user preferences selected from preferred language, preferred learning style, visual presentation for the hearing impaired, auditory presentation for the visually impaired, tactile presentation for the visually impaired, preferred presentation style based on education level, or preferred presentation style based on personal interests.

8. The handheld personal device of claim 1, wherein the venue at which the presence of the at least one user is identified is a museum, an exhibit, a theater, a public space, a theme park, a retail establishment, a restaurant, a cruise ship, a hotel, a resort, a sports arena, or a sports stadium.

9. The handheld personal device of claim 1, wherein the recognition device is configured to identify the at least one user by at least one of facial recognition, scanning a bar code, scanning a QR code, or receiving a near-field communication signal.

10. The handheld personal device of claim 1, wherein the at least one point of interest of the venue includes a plurality of points of interest, and wherein the virtual docent system is configured to generate an itinerary and a path of travel for the at least one user between the points of interest of the plurality of points of interest based on the identified user preferences.
